(19) United States
(12) Patent Application Publication
(10) Pub. No.: US 2023/0365021 A1
(43) Pub. Date: Nov. 16, 2023

(54) ELECTRIC VEHICLE CHARGING SYSTEMS AND METHODS

(71) Applicant: EVOS TECHNOLOGY PTY LTD, Herston, Queensland (AU)

(72) Inventors: Chris Crossman, Herston, Queensland (AU); Seshan Weeratumga, Herston, Queensland (AU); Marcelo Salgado, Herston, Queensland (AU)

(21) Appl. No.: 18/245,506

(22) PCT Filed: Sep. 16, 2021
(86) PCT No.: PCT/AU2021/051071

§ 371 Date: Mar. 15, 2023

(30) Foreign Application Priority Data
Sep. 16, 2020 (AU) 2020903308

(51) Int. Cl. B60L 53/66; B60L 53/67; B60L 53/68; B60L 53/65; B60L 53/126; G06F 21/44

(52) U.S. Cl. CPC B60L 53/665; B60L 53/67; B60L 53/68; B60L 53/65; B60L 53/126; G06F 21/44; G06Q 20/145

(57) ABSTRACT

An electrical vehicle charging system and method is provided. The electric vehicle charging system comprises: a plurality of electric vehicle charging stations; a plurality of electric vehicles, each of the electric vehicles including a vehicle module which includes a positioning module, configured to determine a position of the vehicle, and an identifier associated with the vehicle; and one or more remote servers, coupled to the plurality of electric vehicle charging stations, and the vehicle module. The one or more remote servers are configured to: receive positioning data and the identifier from the vehicle; associate the vehicle with a charging station of the plurality of electric vehicle charging stations according to the positioning data; and cause the associated charging station to charge the electric vehicle upon authentication of the vehicle using the identifier or a derivative thereof.

### TECHNICAL FIELD

The present invention relates to electric vehicle charging, and in particular, although not exclusively, to energy management for electric vehicles.

### BACKGROUND ART

Electric vehicles are becoming an increasingly popular form of transport for multiple reasons, including environmental reasons. These vehicles generally include a rechargeable battery, which powers an electric motor to propel the vehicle.

A problem with electric vehicles is that their batteries must be recharged, and it is more difficult to manage energy for electric vehicles when compared with petrol and other traditional vehicle fuels. Furthermore, the cost of electric vehicle charging stations is generally high, which may pose as a barrier to deployment of electric vehicle fleets.

Similar problems exist with vehicle charging infrastructure that is for shared use, particularly when it comes to funding and monetising electric vehicle charging stations. In short, investment in public vehicle charging infrastructure is complex and expensive, and as such, investment in such infrastructure is generally low.

Alternating current (AC) charging systems are generally simpler, and less costly than direct current (DC) charging systems. However, AC charging systems utilising grid power move control to the vehicle, and the charger generally gets little to no data back from the vehicle. As such, it is generally more difficult to manage energy for electric vehicles when using AC charging systems.

Certain systems exist where third-party systems are used to manage electric vehicle charging costs. Customers are generally required to pay a monthly fee to the third-party system to provide the energy management, and users of the chargers are generally required to authenticate themselves using a smartphone or similar device. As such, these systems are generally inconvenient.

As such, there is clearly a need for an improved electric vehicle charging system.

It will be clearly understood that, if a prior art publication is referred to herein, this reference does not constitute an admission that the publication forms part of the common general knowledge in the art in Australia or in any other country.

### SUMMARY OF INVENTION

The present invention is directed to electric vehicle charging methods and systems which may at least partially overcome at least one of the abovementioned disadvantages or provide the consumer with a useful or commercial choice.

With the foregoing in view, the present invention in one form, resides broadly in an electrical vehicle charging system comprising:
a plurality of electric vehicle charging stations;
a plurality of electric vehicles, each of the electric vehicles including a vehicle module, the vehicle module including a positioning module, configured to determine a position of the vehicle, and an identifier associated with the vehicle; and
one or more remote servers, coupled to the plurality of electric vehicle charging stations, and the vehicle modules;
wherein the one or more remote servers are configured to:
   receive positioning data and the identifier from the vehicle;
   associate the vehicle with a charging station of the plurality of electric vehicle charging stations according to the positioning data; and
   cause the associated charging station to charge the electric vehicle upon authentication of the vehicle using the identifier or a derivative thereof.

Advantageously, the electric vehicle charging system provides a simple way of managing charging of electric vehicles without the need for the use of RFID tags, smartphone apps, fuel cards or the like. The electric vehicle charging system also enables simplified management of electric vehicle fleet energy.

Preferably, the vehicle modules are at least partly wirelessly coupled to the one or more remote servers, e.g. using a cellular wireless network and the Internet.

In case wireless connectivity with the one or more remote servers is unavailable, the identifier, or a derivative thereof, may be provided wirelessly to the charging station for authentication of the vehicle. The charging station may authenticate the vehicle by communicating the identifier or derivative to the one or more remote servers for authentication. Such configuration is particularly useful as a fallback when wireless network connectivity is not available to the vehicle module, e.g. in a network outage, or in an areas without coverage, such as a remote area or in a basement.

The central server may communicate an outcome of the authentication to the charging station to cause the associated charging station to charge the electric vehicle.

The identifier, or a derivative thereof, may automatically be used to authenticate the vehicle. The positioning data and the identifier may be automatically provided upon coupling of the vehicle to the charging station.

The identifier may be generated at least in part according to a vehicle identification number (VIN) of the vehicle, or associated with the VIN of the vehicle. The vehicle module may be configured to verify a VIN of the vehicle matches the identifier. This may prevent a vehicle module from being used in another vehicle in an unauthorised manner.

The charging stations may monitor energy used to charge the vehicle, and allocate details of the energy used to an account associated with the vehicle. This may be used to obtain payment for the energy used.

An account may be associated with two or more of the plurality of vehicles.

The charging stations may provide details of the energy used to a central server.

The one or more servers may obtain pre-payment from an account or credit card associated with the vehicle module prior to activating the vehicle charging station.

The system may be configured to enable a single account to be used across a plurality of charging stations.

The charging stations may be owned or operated by different owners or operators. An account may be associated with each of the different owners or operators, thereby enabling payment to be provided to the owners or operators of the charging stations based upon use.

The charging station may allocate one or more tariff parameters to the energy used. The tariff parameters may be provided to a central server and associated with the energy usage.

The charging station may be configured to receive charging parameters, and charge vehicle according to charging parameters. The charging parameters may be defined independently of a state of charge of the vehicle. Each vehicle may be associated with different charging parameters.

The charging parameters may define when the vehicle is to be charged and when the vehicle is not to be charged. The charging parameters may define a level to which the vehicle is to be charged.

The charging station may further be configured to operate in one or more different modes based upon data from the vehicle. The data from the vehicle may include a charge state of the vehicle.

The vehicle module may be configured to first attempt to connect with the one or more servers using cellular wireless communication, and secondarily connect with the charging station using short range wireless communication if cellular wireless communication with the one or more servers is unavailable.

The charging stations may be located in different geographic locations.

The positioning module may include a GPS module, configured to identify a position (location) of the vehicle module, and thereby the vehicle.

The positioning module may include an ultra-wideband (UWB) module, configured to identify a position (location) of the vehicle module, and thereby the vehicle. The UWB module may communicate with one or more charging stations, or beacons associated therewith, to determine a relative location of the vehicle relative to the one or more charging stations.

The UWB module may be configured to determine a distance between the vehicle module and one or more reference points. The distance may be determined according to time of flight of signals transmitted between the UWB module and the reference points.

The UWB module and/or reference point may be configured to determine directional data between the reference point and vehicle module. The direction data may be determined using two (or more) antennae and by determining a phase difference between a signal received by the two (or more antennae).

The reference points may comprise charging stations and/or beacons.

The UWB module may comply with IEEE 802.15.4a and/or 802.15.4z standards.

The positioning module may include a combination of a GPS module and an UWB module, wherein the GPS module is configured to provide coarse positioning information, which is refined using data from the UWB module.

The vehicle module may be configured to monitor energy provided to the vehicle, and compare same to energy reported to be provided to the vehicle.

The electric vehicle charging stations may include one or more AC charging stations. The electric vehicle charging stations may comprise substantially entirely AC charging stations.

The vehicle module may be configured to receive data from the vehicle.

The vehicle module may be coupled to vehicle. The vehicle module may be integrated into the vehicle.

The vehicle module may include an OBD interface. The vehicle module may receive a state of charge of one or more batteries from the vehicle.

The vehicle module may be configured to track key data of the vehicle. This key data may include energy usage data.

The vehicle module may provide vehicle data to the at least one server.

The system may include two-factor authentication. The two-factor authentication may utilise a smartphone associated with the vehicle.

The vehicle charging stations may be periodically provided with a set of approved vehicle identifiers to enable the vehicle charging stations to authenticate vehicles.

In another form, the invention resides broadly in an electric vehicle charging method comprising:
receiving, on a data interface and from a vehicle, positioning data identifying a position of the vehicle and an identifier identifying the vehicle;
automatically associating the vehicle with a charging station of a plurality of electric vehicle charging stations according to the positioning data; and
causing the associated charging station to charge the electric vehicle upon authentication of the vehicle using the identifier or a derivative thereof.

Preferably, the method includes receiving charge parameters associated with the vehicle, and charging the vehicle according to the charge parameters.

The charging parameters may be defined independently of a state of charge of the vehicle.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 diagrammatically illustrates an electric vehicle charging system, according to an embodiment of the present invention.

FIG. 2 illustrates a schematic of the vehicle module, according to an embodiment of the present invention.

FIG. 3 illustrates a schematic of the charging station, according to an embodiment of the present invention.

FIG. 4 illustrates an exemplary charging scenario using the system, according to an embodiment of the present invention.

FIG. 5 illustrates an electric vehicle charging method, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

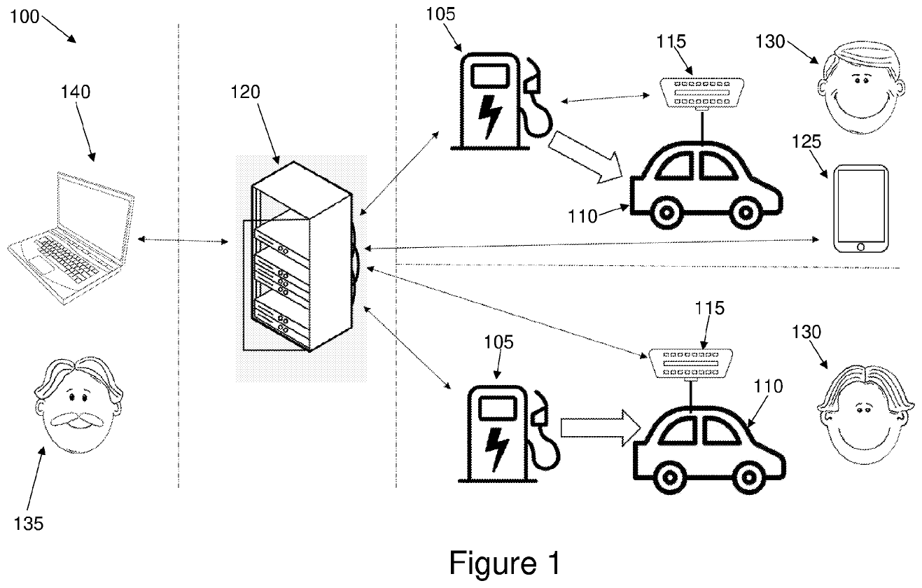

FIG. 1 diagrammatically illustrates an electric vehicle charging system 100, according to an embodiment of the present invention. The electric vehicle charging system 100 enables energy to be distributed in a manner that is accountable, thereby enabling costs to be allocated based upon actual use.

The charging system 100 includes a plurality of charging stations 105, enabling electric vehicles 110 to be charged. The charging stations 105 may be located in different geographic locations, enabling the vehicles 110 to be charged at different geographic locations, as needed. This enables charging to be provided as and when it is needed to the vehicles 110, thereby enabling more efficient energy management.

When an electric vehicle 110 is to be charged, it travels to a charging station 105. The vehicle 110 is coupled to the charging station 105, e.g. physically by a charging cable, or inductively.

The electric vehicles 110 each includes a vehicle module 115 which includes a positioning module, configured to determine a position of the vehicle 110, and a unique identifier associated with the vehicle 110, for authentication of the vehicle 110.

The positioning module include GPS module and an ultra-wideband (UWB) module, to identify a position (location) of the vehicle module 115 and thereby the vehicle 110.

The GPS module is configured to provide coarse positioning information, which is refined using data from the UWB module. This is particularly useful in cases where charging stations are located close to each other, and accurate location information is needed to distinguish between locations, and/or where GPS data is not sufficiently accurate (e.g. in a building or underground carpark).

The ultra-wideband (UWB) module is configured to communicate with one or more charging stations 105, or beacons associated therewith, to determine a relative location of the vehicle relative to the one or more charging stations. The UWB module may determine distance (time of flight data) with reference to a plurality of reference points, and use triangulation to determine a position relative thereto. Similarly, directional data between the reference point and vehicle module may be determined, wherein position is determined according to directional and distance information. The reference points may comprise charging stations 105 and/or beacons.

The UWB module may comply with IEEE 802.15.4a and/or 802.15.4z standards.

The identifier may comprise a key which is used in public key-private key authentication, or any other suitable identifier.

The location of the vehicle, once determined, is sent wirelessly to the central server 120, together with the identifier or a variant thereof, wherein the location of the vehicle module 115 is used to identify a charging station 105 associated with the vehicle. As an illustrative example, the central server 120 may identify the charging station 105 based on a geo-fence associated with the charger.

The identified vehicle charging station 105 is activated by the central server 120, upon authentication of the vehicle module 115. The server 120 may obtain pre-payment from an account or credit card associated with the vehicle module 115, or determine that the account is not in arrears, prior to activating the vehicle charging station 105.

The charging station 105 monitors the amount of energy provided to the vehicle 110, informs the server 120 of this amount, which allocates this to the vehicle for accounting purposes.

The vehicle module 115 connects wirelessly to the central server 120 using long range wireless communication, such as 4G or 5G cellular data, where possible. The vehicle module 115 may alternatively connect directly to the charging station 105, e.g. using short range wireless communication, such as Bluetooth. In such case, the identifier, or derivative thereof, is then provided for authentication, which is provided to the server 120 by the charging station 105, upon which the vehicle is authenticated and subsequently charged.

In one embodiment, the vehicle module 115 attempts to connect wirelessly to the central server 120, and connect directly to the charging station 105 only if direct connection to the central server 120 is not available.

In other embodiments, the vehicle charging stations 105 are periodically provided with a set of approved vehicle identifiers (a white list), thereby enabling the vehicle charging stations 105 to authenticate and charge vehicles when connection with the server 120 is unavailable. In such case, the server 120 and vehicle charging station 105 may communicate periodically, e.g. nightly, using communication channels that may not be suitable for real time communication.

As the vehicle 110 is charged, the charging station 105 monitors energy usage, and associates that with the vehicle 110. This can be in the form of energy delivered alone (e.g. as kWh delivered), or in combination with one or more other parameters, such as tariff parameters (e.g. rate). This enables different rates to be charged at different times of day, such as at lower rates when photo-voltaic solar cells are generating energy at the charging station (e.g. during daytime) or when excess energy is generated, than when battery storage or mains power must be used.

The energy consumption data is provided to the server 120, e.g. immediately, or in bulk at a later time. The server 120 is then able to allocate such usage to an account of or associated with the vehicle 110. The server 120 may include a billing system to provide monthly accounting to the owner of the vehicle or a suitable account holder.

The vehicle module 115 may be in the form of a OBD2 device that communicates with the vehicle 110, e.g. using a CAN bus of the vehicle 110. In other embodiments, the vehicle module 115 may be built into the vehicle 110, either at the time of manufacture, or at a later time. Similarly, the vehicle module can utilize OBD II, SAE J1939, CANopen or CAN FD standards to communicate with the vehicle. Data of the vehicle can be logged and sent to the server 120.

Data from the vehicle 110, or derivatives thereof, may be provided to the charging station 105 or server 120 to control charging of the vehicle based upon such data. As an illustrative example, the charging station 105 may operate in one or more different modes based upon data from the vehicle 110. The data from the vehicle 110 may include a charge state of the vehicle 110, a temperature of the battery of the vehicle 110, or any other suitable parameter of or associated with the vehicle 110.

Similarly, the data from the vehicle 110 and vehicle module 115 may be used to determine that the charging station 105 is functioning correctly, and to audit energy provided by the charging station 105. This may prevent fraud associated with charging stations 105, and identify problems with charging stations 105 at an early stage. In one embodiment, the vehicle module 115 may compare energy delivered by the charging station 105, as reported by the charging station 105, with energy received by the vehicle 110.

In addition to enabling authentication using the identifier of the vehicle 110, the system may utilise two-factor authentication. In such case, a message may be sent to a smartphone 125 of an operator 130 of the vehicle 110. The operator 130 may then confirm or cancel the transaction, preventing unauthorised charging of the vehicle 110 (or another vehicle impersonating the vehicle 110).

One or more administrators 135 may connect to the server 120 using respective computing devices 140, and configure the system 100 and/or set charging parameters of vehicles 110 or groups of vehicles 110. As an illustrative example, an administrator 135 may be associated with a fleet of vehicles for a particular company, and set charging parameters for the company. The charging parameters may include charging preferences, and may be used by charging stations to determine charging settings and/or rates. As an illustrative example, the charging parameters may include charging preferences, such that lower amounts of energy are utilised from undesirable charging stations compared with desirable charging stations.

In short, the system 100 enables charging stations 105 to be monetised in a manner that was previously not possible. This in turn may increase investment in charging stations 105, including the building of charging stations, as investors are able to receive a clear return on investment.

The system 100 is particularly suited to AC charging of vehicles, and the charging stations 105 may comprise AC chargers. The skilled addressee will, however, appreciate that the system may be used with any type of vehicle charging, including a combination of different technologies (e.g. AC, DC and/or inductive charging). One of the benefits of AC charging of vehicles, however, is that it is relatively simple, and therefore the cost (and thus threshold) for building an AC charging station is relatively low.

In fact, the system 100 enables homes to become charging stations relatively inexpensively, which is particularly useful when company vehicles are charged at home overnight. The system may enable utility providers or homeowners to bill the company directly for used energy, and may simplify the process for accounting for energy usage. In such case, a relatively simple charger may be provided that utilises the existing AC network (solar or grid).

Similarly, apartment buildings may include such charging stations in common areas (e.g. a basement), for the benefit of residents, and in such case may bill residents directly for the amount of energy used, in a similar manner to how gas and hot water usage can be apportioned to residents based on use.

The charging stations 105 may be owned or operated by different entities. As an illustrative example, a shop owner may buy or install a charging station 105 in association with his or her shop, and power it using mains power from an existing network or solar system. As an operator 130 of a vehicle 110 charges his or her vehicle at that charging station, the operator 130 (or an accountholder associated with the vehicle 110) is charged for the used energy. The owner (or operator) of the charging station 105 then receives payment for the used energy.

The charging stations 105 may provide energy at different costs to each other, at different costs at different times of day, or based upon any suitable factor. As an illustrative example, a charging station 105 may provide excess energy (e.g. solar energy that is not otherwise used) at a relatively low cost when available, and energy otherwise at a relatively higher rate. In combination with charging settings, as outlined above, charging may be automatically turned on and off to a particular vehicle based on factors such as availability, tariffs and the settings.

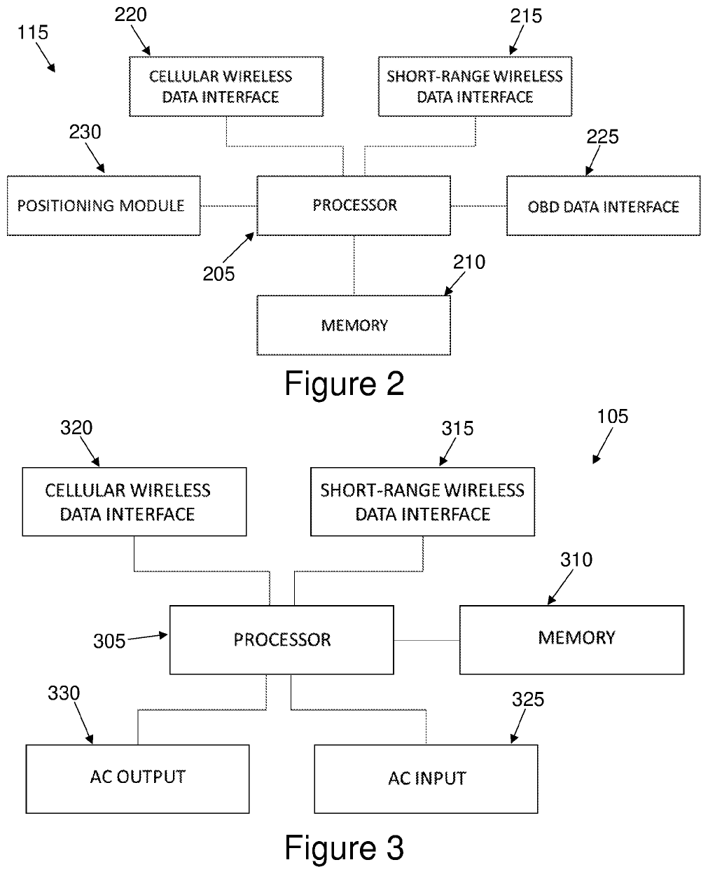

FIG. 2 illustrates a schematic of the vehicle module 115, according to an embodiment of the present invention.

The vehicle module 115 includes a processor 205 and a memory 210. The memory 210 includes instruction code executable by the processor 205 to perform various functions of the vehicle module 115. The memory 210 further includes an identifier associated with the vehicle, enabling authentication thereof.

The vehicle module 115 further includes a short-range wireless data interface 215, such as a Bluetooth interface, and a cellular wireless data interface 220, such as a 4G or 5G data interface, to enable short-range and long-range communication respectively. The short-range interface 215 is particularly suited for connecting to a charging station, whereas the cellular wireless data interface 220 is particularly suited for connecting to a remote server via the Internet.

The vehicle module 115 further includes an on-board diagnostics (OBD) data interface 225, enabling the vehicle module 115 to communicate with the vehicle, e.g. via a Controller Area Network (CAN) bus thereof. The vehicle module 115 may retrieve information from the vehicle in such manner including a state of charge of the batteries, temperature data, or any other suitable vehicle information.

Finally, the vehicle module 115 includes a positioning module 230, to enable location data of the vehicle module 115 to be identified. The positioning module 230 may include a GPS and UWB module. This location data may be used by a remote server to identify a charging station in proximity to the vehicle.

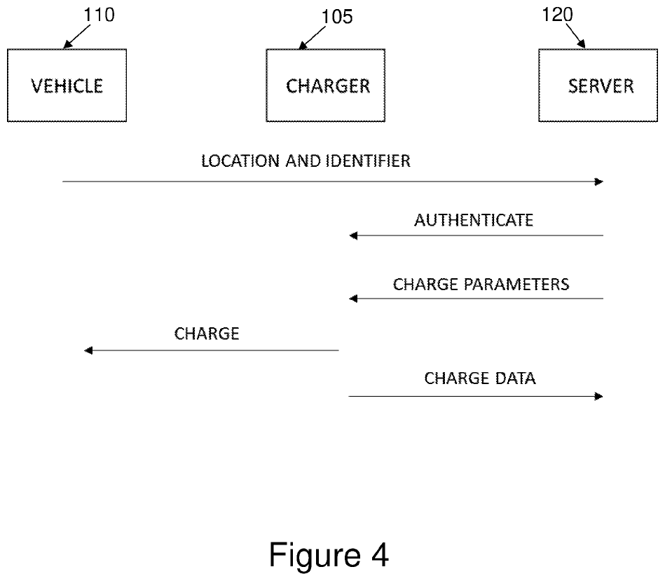

FIG. 3 illustrates a schematic of the charging station 105, according to an embodiment of the present invention.

The charging station 105 includes a processor 305 and a memory 310, the memory 310 including instruction code executable by the processor 305 to perform various functions of the charging station 105. The memory 210 may also include an identifier associated with the charging station 105, enabling each of the charging stations to be individually identified.

The charging station 105 further includes a short-range wireless data interface 315, such as a Bluetooth interface, and a cellular wireless data interface 220, such as a 4G or 5G data interface, to enable short-range and long-range communication respectively. The short-range interface 215 is particularly suited for connecting to a vehicle (vehicle module), whereas the cellular wireless data interface 220 is particularly suited for connecting to a remote server via the Internet.

The charging station 105 includes an AC input 325, which may be in the form of mains power, output from a solar inverter, a storage battery, or any suitable combination thereof (or alternative power sources), and an AC output 325. The AC output is for coupling to an electric vehicle for charging thereof.

In one embodiment, the AC output comprises one, two or four 22 kW AC charger outputs for delivery of energy to the electric vehicles. A single 22 kW charger is particularly suited to a home environment, whereas a dual or quad AC charger is particularly suited to away-from-home charging scenarios.

The charging station 105 may receive charging parameters relating to the vehicle upon authentication of the vehicle, and charge the vehicle according to the charging parameters. In one exemplary situation, a vehicle may be configured such that it is only charged using low cost (e.g. excess) power. In such case, the processor 305 may cause charging to start and stop by turning on and off the AC output 330 when such power is available and not.

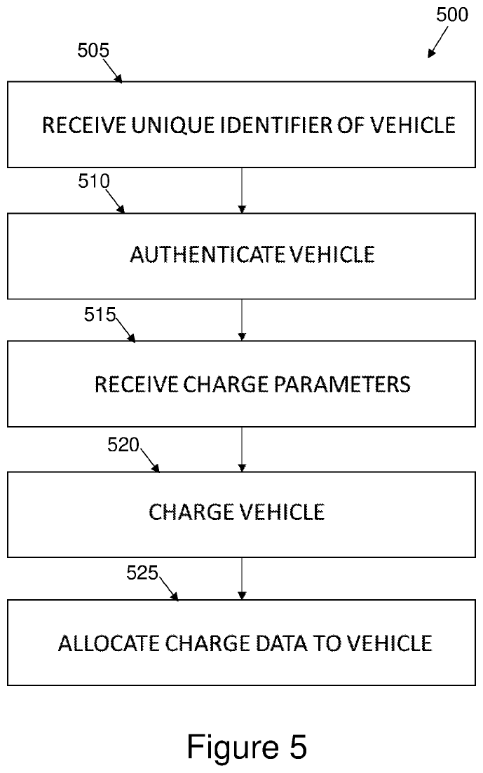

FIG. 4 illustrates an exemplary charging scenario using the system 100, according to an embodiment of the present invention.

Initially, the vehicle module 115 determines the location (position) of the vehicle 110. This may be automatically performed when the vehicle is plugged into a charging station 105, for example, and may be performed using GPS, UWB and/or other data.

The vehicle module 115 then submits the location and an identifier (or derivative thereof) to the server 120. The identifier (or derivative) is for authentication.

The server 120 may then verify that funds are available to charge the vehicle 110, and allocate funds associated for such purpose (e.g. obtain a pre-payment). The server 120 then authenticates the vehicle by sending an authentication confirmation message to the charger 105.

The server 120 also retrieves charging parameters associated with the vehicle. As outlined above, each vehicle may be associated with different charging parameters, and the charging parameters may define a priority of the charging. As an example, a vehicle 110 may choose to receive only low cost (e.g. excess) power. In other example, a vehicle 110 may choose to receive only solar power, and not mains power, e.g. for environmental reasons. In yet another example, a vehicle may choose to be charged up to a certain level (e.g. 50%) using external power.

The vehicle 110 is then charged by the charging station 105 using the charging parameters. This may include turning the charging station 105 on and off. The charging station 105 also sends charge data to the server 120, such as charge volume (kWh).

In addition to controlling charging, the vehicle module 115 may be configured to track key data of the vehicle 110. This key data may include energy data (e.g. energy usage), and travelled distance, speed and/or any other suitable data. Such data may be provided to the server 120, enabling the administrator 135 to track statistics over a number of vehicles, thereby identifying trends or deviations in data. This in turn enables the administrator 135 to make educated decisions on how to utilise the energy powering their electric fleet in the most cost effective and efficient way.

As outlined above, each vehicle module 115 is associated with a unique identifier. The identifier may, for example, comprise a vehicle identification number read from the vehicle 110, or a derivative thereof. As such, each vehicle module 115 need not be associated with a unique identifier that is independent of the vehicle.

The system is particularly useful in simplifying investment in charging infrastructure. As an illustrative example, in addition to being able to purchase the hardware described above, options may be provided where a third party manages the installation and maintenance of the hardware, the purchase of energy, and the charging management system, thereby providing electric vehicle energy as a service (removing the CAPEX cost and providing a simple OPEX cost for fleets).

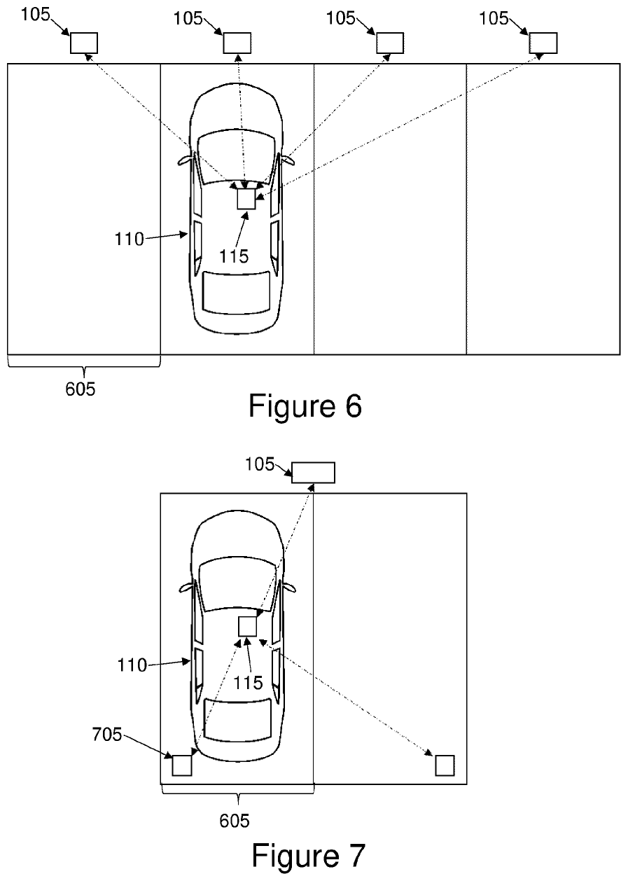

FIG. 5 illustrates an electric vehicle charging method 500, according to an embodiment of the present invention. The method 500 may be similar or identical to the method performed by the system 100.

At step 505, the method 500 includes receiving an identifier of the vehicle, or a derivative thereof. The identifier may comprise a key (or a derivative of a key), in a public key-private key authentication system. The identifier may also be associated with a unique identifier of the vehicle, such as a VIN of the vehicle.

At step 510, the vehicle is authenticated using the identifier of the vehicle. The authentication may comprise authenticating using the identifier alone, or using other information. As an illustrative example, authentication of the vehicle may include obtaining pre-payment from an account associated with the vehicle.

At step 515, charge parameters associated with the vehicle are received. The charge parameters may be set by an administrator for the vehicle (or a group of vehicles) based upon one or more preferences. As an illustrative example, when outside of a preferred charging network, the charge parameters may define that only excess energy (or inexpensive energy) be used to charge the batteries of the vehicle.

At step 520, the vehicle is charged according to the charge parameters. This may include turning the charger on and off according to energy availability, cost or other parameters. The energy used in charging, as well as any associated parameters, are monitored while the vehicle is charging.

At step 525, the monitored energy used is allocated to the vehicle as charge data. The charge data may be used to generate invoices or to bill for the energy used.

As outlined above, the positioning of the vehicle may be performed, at least in part, using an UWB module of the vehicle module 115 of the vehicle. This may assist in localising the vehicle in areas where GPS is not sufficiently accurate, e.g. when multiple parking spaces and charges are provided in close proximity to each other, and/or where GPS may not be accurate (e.g. underground).

FIG. 6 illustrates an exemplary configuration of a number of charging stations 105, each associated with a different parking space.

When the vehicle 110 enters a parking space, the UWB module of the vehicle module 115 communicates with the different charging stations 105, and measures a time of flight to and/or from each of the charging stations 105. This different in time of flight is then able to triangulate a location of the vehicle 110, from which a parking space 605 may be determined, and thereby an associated charge station 105.

While the car parks 605 are illustrated as being in a single row, the skilled addressee will readily appreciate that any configuration may be used, including parallel rows of parking. Similarly, while a single charge station 105 is associated with each car park 605, in other embodiments, a charging station may be shared between two (or multiple) car parks. In such case, the charging station would generally include a charging point for each car park.

Similarly, while the UWB module of the vehicle module 115 may interact with the charging stations 105 to determine a location, in other embodiments, beacons may be positioned in parking spaces.

FIG. 7 illustrates an exemplary configuration of a single charging station 105, associated with two car parks 605. The charging station 105 includes include a charging point (not illustrated) for each car park.

First and second beacons 705 are provided in the car parks 605. When the vehicle 110 enters a parking space, the UWB module of the vehicle module 115 communicates with the charging stations 105 and the beacons 705, and measures a time of flight to and/or from each of the charging station 105 and beacons 705. This different in time of flight is then able to triangulate a location of the vehicle 110, from which a parking space 605 may be determined, and thereby an associated charging station 105.

In alternative embodiments, The UWB module and/or reference point may be configured to determine directional data between a reference point and vehicle module. The direction data may be determined using two (or more) antennae and by determining a phase difference between a signal received by the two (or more antennae). Position may then be determined using distance and direction with reference to a reference point.

This location information (i.e. which car park or charging station the vehicle is associated with) may be provided to the server 120, as outlined above, to initiate charging.

As outlined above, the vehicle module in the vehicle may be coupled to a CAN bus of the vehicle and may obtain a report a variety of data. Examples of such data include state of charge (SOC) of the batteries, kW delivered, time to charge, battery temperature, voltage and health, vehicle unique ID (e.g. VIN), KMs travelled, and route information.

The charging stations may operate according to any suitable standard or protocol. In one embodiment, the charging stations may operate according to the Open Charge Point Protocol (OCPP) 2.0. The charging stations may similarly include other functionality, such as remote diagnostics functionality, and may be provided in a robust IP65 enclosure.

In addition to vehicle charging, the systems and methods may provide grid monitoring, load management, smart charging, service and maintenance, smart driver analytics and route planning.

Advantageously, the methods and systems described above provide a simple way of managing charging of electric vehicles without the need for the use of RFID tags, smartphone apps, fuel cards or the like. As an illustrative example, a vehicle may simply be plugged in (or otherwise coupled to a charger), upon which it is automatically charged according to pre-defined parameters, dynamic factors (such as availability of different forms of energy), and charged automatically to an account associated with the vehicle.

As interaction with the charging station is reduced, safety may be increased. As an illustrative example, users are not required to use keypads, and minimal contact with charging equipment is possible.

Charging stations may be installed in common areas of shared buildings. The system may be used to bill vehicle owners for power that is consumed from the common areas and may be used to restrict usage to residents or other authorised users, if desired.

Charging stations may be installed in homes, and businesses can reimburse employees for power the employee charges the car with at their home, much like power used elsewhere. Vehicle monitoring may also provide data for fringe benefits tax requirements.

The electric vehicle charging system also enables simplified management of electric vehicle fleet energy.

The methods and systems optimise customer experience and value, which in turn promotes electric vehicle usage. The ability to automatically authenticate the vehicle removes the need for RFID cards, fuel cards, credit cards or apps.

The methods and systems may gather vital data from the vehicle to simplify the vehicle and charger operation, reduce the cost of energy, improve the use of energy, and verify key data using multiple sources.

The methods and systems enable private electric vehicle charging parks to be developed and commercialised, by enabling owners or operators to sell their energy to electric vehicle operators. Similarly, a third-party may manage the installation and maintenance of the hardware, purchase of energy, and management platform for a fee, thereby transforming a capital expenditure into an operating expenditure.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An electrical vehicle charging system comprising:
a plurality of electric vehicle charging stations;
a plurality of electric vehicles, each of the electric vehicles including a vehicle module, the vehicle module includes a positioning module, configured to determine a position of the vehicle, and an identifier associated with the vehicle; and
one or more remote servers, coupled to the plurality of electric vehicle charging stations, and the vehicle modules;
wherein the one or more remote servers are configured to:
receive positioning data and the identifier from the vehicle;
associate the vehicle with a charging station of the plurality of electric vehicle charging stations according to the positioning data; and
cause the associated charging station to charge the electric vehicle upon authentication of the vehicle using the identifier or a derivative thereof.

2. The electrical vehicle charging system of claim 1, wherein the vehicle modules are at least partly wirelessly coupled to the one or more remote servers

3. The electrical vehicle charging system of claim 2, wherein when wireless connectivity with the one or more remote servers is unavailable, the identifier, or a derivative thereof, is provided wirelessly to the charging station for authentication of the vehicle.

4. The electrical vehicle charging system of claim 3, wherein the charging station authenticates the vehicle by communicating the identifier or derivative to the one or more remote servers for authentication.

5. The electrical vehicle charging system of claim 1, wherein the central server communicates an outcome of the authentication to the charging station to cause the associated charging station to charge the electric vehicle.

6. The electrical vehicle charging system of claim 1, wherein the positioning data and the identifier are automatically provided to the server upon coupling of the vehicle to the charging station.

7. The electrical vehicle charging system of claim 1, wherein the identifier is generated at least in part according to a vehicle identification number (VIN) of the vehicle, or otherwise associated with the VIN of the vehicle.

8. The electrical vehicle charging system of claim 7, wherein the vehicle module is configured to verify a VIN of the vehicle.

9. The electrical vehicle charging system of claim 1, wherein the charging station monitors energy used to charge the vehicle, and allocates details of the energy used to an account associated with the vehicle.

10. The electrical vehicle charging system of claim 1, wherein the charging station is configured to receive charging parameters, and charge the vehicle according to charging parameters.

11. The electrical vehicle charging system of claim 10, wherein the charging parameters are defined independently of a state of charge of the vehicle.

12. The electrical vehicle charging system of claim 1, wherein the positioning module includes a GPS module, configured to identify a position (location) of the vehicle module, and thereby the vehicle.

13. The electrical vehicle charging system of claim 1, wherein the positioning module includes an ultra-wideband (UWB) module, configured to identify a position (location) of the vehicle module, and thereby the vehicle.

14. The electrical vehicle charging system of claim 13, wherein the UWB module communicates with one or more charging stations, or beacons associated therewith, to determine a relative location of the vehicle relative to the one or more charging stations.

15. The electrical vehicle charging system of claim 13, wherein the UWB module is configured to a) determine distance (by time of flight) with reference to a plurality of reference points, and use triangulation to determine a position relative thereto; or b) determine distance and directional data with reference to a reference point to determine a position relative thereto.

16. The electrical vehicle charging system of claim 1, wherein the positioning module includes a combination of a GPS module and an UWB module, wherein the GPS module is configured to provide coarse positioning information, which is refined using data from the UWB module.

17. The electrical vehicle charging system of claim 1, wherein the electric vehicle charging stations include one or more AC charging stations.

18. The electrical vehicle charging system of claim 17, wherein the electric vehicle charging stations comprise substantially entirely AC charging stations.

19. The electrical vehicle charging system of claim 1, wherein the vehicle module is configured to receive data from the vehicle, and provide the vehicle data to the at least one server.

20. An electric vehicle charging method comprising:
receiving, on a data interface and from a vehicle, positioning data identifying a position of the vehicle and an identifier identifying the vehicle;
automatically associating the vehicle with a charging station of a plurality of electric vehicle charging stations according to the positioning data; and
causing the associated charging station to charge the electric vehicle upon authentication of the vehicle using the identifier or a derivative thereof.
